(19) United States
(12) Patent Application Publication
(10) Pub. No.: US 2007/0021966 A1
(43) Pub. Date: Jan. 25, 2007

(54) Systems and methods for facilitating service request processing in a call center

(75) Inventors: Jean Marie Ellefson, Fairport, NY (US); Rajinderjeet Singh Minhas, Penfield, NY (US); Fei Xiao, Penfield, NY (US)

Correspondence Address: Maginot, Moore & Beck LLP, Chase Tower, Suite 3250, 111 Monument Circle, Indianapolis, IN, 46204-5109, US

(73) Assignee: Xerox Corporation

(21) Appl. No.: 11/185,170

(22) Filed: Jul. 20, 2005

(51) Int. Cl. G06Q 99/00

(52) U.S. Cl. 705/1

(57) ABSTRACT

A call center system comprises a service request generator for generating a service request that includes a machine identifier; a machine status database controller coupled to the service request generator, the machine status database controller for retrieving machine status data corresponding to the machine identifier of the service request; a historical solution database controller coupled to the machine status database controller, the historical solution database controller for retrieving historical solution data corresponding to the retrieved machine status data; and a service plan generator coupled to the service request generator, the machine status database controller, and the historical solution database controller, the service plan generator for generating a repair code for the service request that corresponds to the retrieved machine status data and retrieved historical solution data.

### TECHNICAL FIELD

The systems and methods described herein relate to call centers for processing service requests for machine maintenance and, more particularly, they relate to call centers that process service requests for office machine maintenance.

### BACKGROUND

In the current market environment, particularly in regard to office equipment such as printers, copiers, and computers, an economic premium is placed on the ability for remote service personnel to interact with a customer as soon as the customer needs help. Twenty-four hour service lines are common in various industries to provide access to personnel trained to assist a user of a machine.

Office equipment typically uses a software-based operating system to perform essential machine functions and implement the various jobs of which the machine is capable. These software systems, particularly those used in high-speed multi-function machines, are subject to various problems and faults. Additional problems also arise with the machine hardware which, in machines of this type, is extremely complex and sophisticated. While these systems may provide a user with an error message or corrective action message, these messages do not always make sense to a user. Some of these hardware and software problems occur relatively infrequently and may be difficult to recognize and resolve.

Typically, each customer service representative in a call center has an associated station that typically includes a personal computer or workstation and a telephone with a headset. The workstation may be used to access a customer service database to confirm the customer's account and authorization to receive technical support. The workstation may also be used to access the service history for the machine about which the customer is calling to determine whether regularly scheduled maintenance or part replacement is appropriate. The customer service representative may use the service database information to help a caller.

In situations where the customer is unable to resolve the problem on his or her own, the customer may call the technical support call center to speak with a customer service representative regarding the problem. The customer service representative may advise the customer (hereinafter referred to as the “user”) to perform minor corrections or repairs to the machine, such as removing jammed paper, etc., in the case of a printer or copier. If the problem cannot be solved over the phone, the customer service representative may schedule an onsite visit by a service technician to diagnose and repair the machine.

Timely resolution of customer problems builds goodwill with a manufacturer's customer base. A remote problem resolution also reduces the machine down time. A service technician visit may be accompanied by the machine being down for a significant amount of time before the problem is resolved. A customer would prefer resolution of the problem during the call to the service center rather than waiting for a technician to arrive and perform a repair. Unfortunately, resolution of a service request during a service call currently depends upon the expertise and experience of the service representative. Although a service representative may be able to collect information about the machine, such as serial number, model identifier, and problem symptoms, from the user, the service representative has to rely upon his or her experience in solving problems for that type of machine in order to suggest possible solutions for the problem over the telephone. Additionally, the user may become frustrated after one or two attempts have failed and request a technician visit even though other solutions remain to be tried during the telephone call.

### SUMMARY

A call center system described in this application facilitates the processing of service requests at a call center by assisting a customer service representative in determining whether efforts to solve the problem during the telephone session have a reasonable chance of success and providing an estimate of time for attempting the efforts. The call center system comprises a service request generator for generating a service request that includes a machine identifier; a machine status database controller coupled to the service request generator, the machine status database controller for retrieving machine status data corresponding to the machine identifier of the service request; a historical solution database controller coupled to the machine status database controller, the historical solution database controller for retrieving historical solution data corresponding to the retrieved machine status data; and a service plan generator coupled to the service request generator, the service plan generator for generating a repair code for the service request that corresponds to the retrieved machine status data and the retrieved historical solution data. The repair code indicates whether the service request can be solved over the phone or whether an on-site technician will have to be dispatched to repair the machine.

In an alternative embodiment, the service plan generator generates an estimated resolution time for a repair code that corresponds to a solution being achieved during the telephone session. In this embodiment, the service plan generator analyzes the retrieved historical solution data, in particular, the resolution time data of previously resolved similar service requests. Once the analysis is completed, the service plan generator generates an estimated resolution time for the remote solve repair code. When the repair code indicates that a remote solve is not possible, the customer service representative has the option of immediately informing the user that an onsite technician is being dispatched.

The systems described herein enable a method to be performed that facilitates the processing of service requests at a call center. The method comprises generating a service request that includes a machine identifier; retrieving machine status data corresponding to the machine identifier of the service request; retrieving historical solution data corresponding to the retrieved machine status data; and generating a repair code for the service request that corresponds to the retrieved historical solution data. The repair code indicates whether the service request can be solved over the phone or whether an on-site technician will have to be dispatched to repair the machine. The method may further comprise generating an estimated remote resolution time corresponding to the retrieved historical solution data.

The systems and method, described in more detail below, enable a call center to access machine status data in order to determine the probability a service request can be solved over the phone or whether an on-site technician should be dispatched to repair the machine. The systems and method enable a determination of an estimated resolution time for resolving the service request during the telephone session so the user can decide whether a remote solution should be attempted before sending a service technician.

Other benefits and advantages of the call center systems and methods will become apparent upon reading and understanding the following drawings and specification.

### BRIEF DESCRIPTION OF THE DRAWINGS

The preferred embodiments will be described in detail, with reference to the following figures, wherein:

FIG. 1 is an illustration of a system comprising a call center system, a data acquisition system, and one or more monitored electronic devices; and

FIG. 2 is a functional block diagram illustrating a first exemplary embodiment of the system of FIG. 1;

FIG. 3 is a flow diagram of an exemplary method for generating a repair code for a service request based on machine status data and call center historical data.

### DETAILED DESCRIPTION

Although the various embodiments are illustrated below in conjunction with the processing of communications in an exemplary system, other particular system configurations may be used. Those skilled in the art will recognize that a variety of different communication processing system configurations, such as automatic call distribution (ACD) systems, telemarketing systems, private-branch exchange (PBX) systems, computer-telephony integration (CTI)-based systems, as well as in combinations of these and other types of call center switch configurations may be used. A call center may also be configured using any type of network infrastructure, such as, e.g., asynchronous transfer mode (ATM), local area networks, wide area networks, etc. as well as combinations of these and other networks. The term “call center” as used herein is intended to include any type of ACD system, telemarketing system or other communication system which processes calls or other service requests, including voice calls, Internet protocol (IP) communications, video calls, multimedia calls, e-mail, faxes, text chat, voice over IP or voice messages as well as various portions or combinations of these and other types of communications. The term “call” as used herein is intended to include any of the above-noted types of communications as well as portions or combinations of these and other communications. In addition, the systems and methods described herein are applicable to the processing of incoming communications, outgoing communications or both.

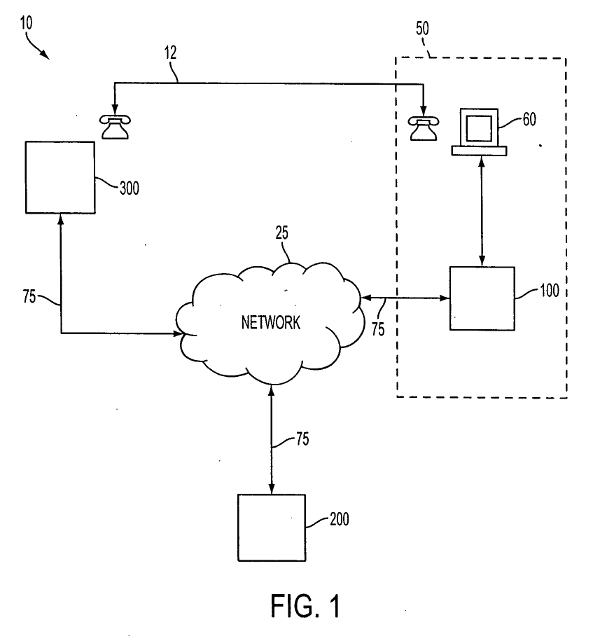

In the drawings, like reference numerals have been used throughout to designate like elements. As shown in FIG. 1, the system 10 comprises a call center 50, a data acquisition system 200, and one or more monitored electronic machines 300. The various components of the system 10 are interconnected with links 75 to one or more networks 25, additional diagnostics servers and/or other electronic systems.

The network 25 can be any one of, or combination of, a direct serial connection, a distributed network such as an intranet, a local area network, a metropolitan area network, a wide area network, a satellite communication network, an infrared communication network, the Internet, or the like. Furthermore, the links 75 can be a wired or wireless link or any other known or later developed element(s) that is capable of supplying electronic data to and from the connected elements.

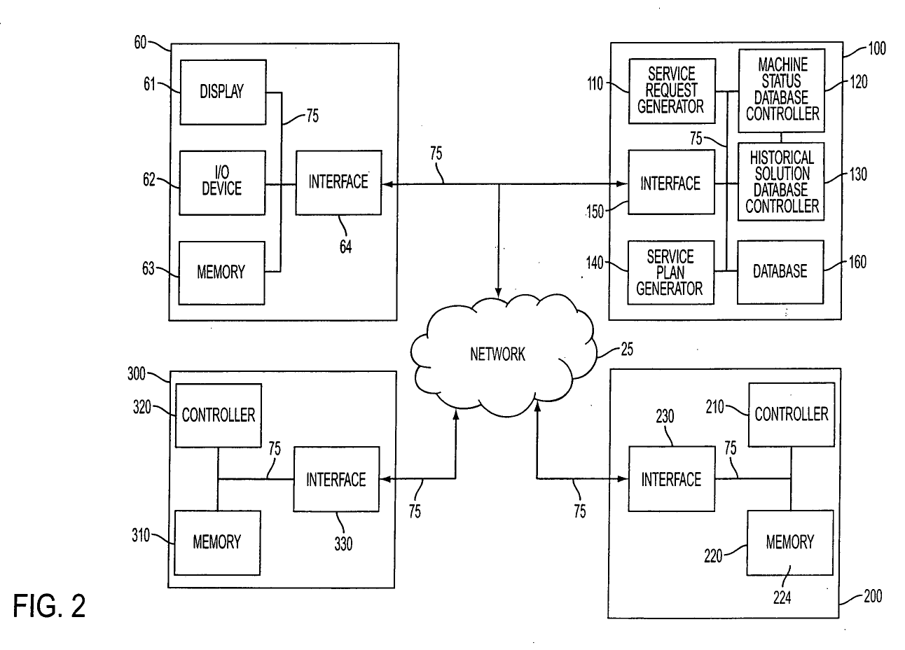

As shown in FIG. 1, the call center 50 comprises at least one customer service representative, at least one call center access device 60, and a call center system 100. With reference to FIG. 2, the call center access device may be a terminal, such as a personal computer, for example. The terminal includes a display 61, one or more I/O devices 62, a memory 63, and a call center interface 64, all interconnected by link 75. It should be appreciated the links 75 can be any known or later developed wired or wireless links or a data bus that is capable of supplying electronic data to and from the connected elements. The call center interface 64 provides access to the call center system 100 (explained in more detail below) for communicating information to and from the call center system 100. I/O device 62 may be a keyboard or mouse. The display 61 operates to display information received from the call center system 100 or from the I/O device 62.

The data acquisition system 200 comprises a data acquisition controller 210, a memory 220 and an I/O interface 230. The data acquisition controller 210 may be any known or later developed mechanism, such as a server or client that is capable of posting machine status data from a monitored electronic machine 300 on the distributed network 25 and receiving data from the distributed network. The data acquisition controller 210 receives machine status data from one or more of the monitored electronic machines 300 and stores the received machine status data in a machine status database 224 implemented in the memory 220 of the data acquisition system 200. The data acquisition controller 210 operates to add, delete, and update the machine status data items in the machine status database 224 when listings are added or deleted, or when information changes.

The one or more monitored electronic machines 300 comprise a memory 310, a machine controller 320, a machine I/O interface 330, all interconnected by link 75. The one or more monitored machines 300 further include a machine identifier (not shown). The machine identifiers may take many different forms as long as they uniquely identify a machine or a group of machines such as a serial number or a model number.

In operation, the one or more monitored electronic machines 300 generate machine status information, e.g., control data, process data, and diagnostic data, during the course of operation. Specifically, during the course of operation, machine status data is generated pertaining to the operational state of the one or more monitored electronic systems 300. For example, this machine status data can be as simple as an on/off status of the electronic system to highly specialized data which could, for example, pertain to itemization of one or more components within the system which have actually failed. Moreover, the data could be as simple as a single component on-off data to system level measurement data. Specially, the data can include, but is not limited to control data such as commands issued by system and subsystem controllers, scheduling and timing data, set-point and actuator data, sensor data, state estimate data and the like, diagnostic data such as fault counts, error counts, event counts, warning and interlock counts, calibration data, device set-up data, high frequency service item information, service history data, machine history data and the like, environmental data such as temperature and humidity data, machine usage data machine configuration data value-added diagnostic data such as trend information, component signatures, qualitative state estimates, quantitative state estimates, and the like.

Additionally, the machine status data could be generated as part of the normal operation of the device, or in response to specific interrogation and control commands issued by an external agent such as the data acquisition controller 210. For example, in the case of printing systems, the data could also include job level data such as number of pages in the job, the type of media used, the size of the job, the printing options, the finishing options, the number of pages actually printed, the number of images actually processed, and the like. Moreover, the data could be acquired in various operational modes of the device, including, but not limited to, normal, failed, diagnostic, limp-along, or the like.

Having determined the machine status data for the particular electronic system, the machine status data along with the machine identifier is forwarded to the data acquisition system 200 via link 75 and the network 25. The data acquisition system 200 having received the machine status data from the monitored electronic system 300 stores the machine status data in the machine status database 224. The machine status database 224 has the capability of storing status information pertaining to a plurality of monitored electronic machines 300.

FIG. 2 illustrates the call center system 100. The call center system 100 comprises an I/O interface 150, a service request generator 110 for generating a service request that includes a machine identifier; a machine status database controller 120 coupled to the service request generator 110, the machine status database controller 120 for retrieving machine status data corresponding to the machine identifier of the service request; a historical solution database controller 130 coupled to the machine status database controller 120, the historical solution database controller 130 for retrieving historical solution data corresponding to the retrieved machine status data; and a service plan generator 140 coupled to the service request generator 110, the machine status database controller 120, and the historical solution database controller 130, the service plan generator 140 for generating a repair code for the service request that corresponds to the retrieved machine status data and retrieved historical solution data. The components of the call center system 100 are all interconnected by links 75. It should be appreciated the links 75 can be any known or later developed wired or wireless links or a data bus that is capable of supplying electronic data to and from the connected elements.

With reference to FIG. 1, a transaction between a user of a monitored machine 300 and the call center 50 is initiated when the user perceives a problem with the machine 300. The user calls the call center 50 and provides the call center with the machine identifier of the machine 300. Although the user may use a land line telephone system, as identified by the reference numeral 12, to contact the call center, other communication modes, known or developed in the future, may be used such as wireless methods, internet telephony, or combinations thereof. An internet telephony message may, for example, automatically include the machine identifier rather than requiring the user to provide it verbally. The call center 50 routes the call to a customer service representative who has access to the call center system 100 through the call center access device 60. The customer service representative enters the machine identifier into the terminal 60 using the I/O device 62. The machine identifier is then provided to the call center system 100 via the interface 64.

The service request generator 110 receives the machine identifier through the call center access interface 64. The service request generator 110 generates a service request including the machine identifier and communicates the service request to the machine status database controller 120 through link 75.

The machine status database controller 120 receives the service request, including the machine identifier, from the service request generator 110. The machine status database controller 120 retrieves the machine status data corresponding to the machine identifier from the machine status database 224. The machine status database controller 120 forwards the retrieved machine status data to the historical solution database controller 130 and the service plan generator 140.

The historical solution database controller 130 receives the retrieved machine status data from the machine status database controller 120 and retrieves the historical solution data from the historical solution database 160 corresponding to the retrieved machine status data. That is, the machine status data may be used to formulate database queries for past solutions to the same or similar problems on the same model or type of machine identified in the service request. The historical solution database 160 contains historical solution data pertaining to previously processed service requests. The historical solution database controller 130 may query the historical solution database for repair code information, fault code information, repair instructions, types of repairs performed, the parts used to perform a repair, whether the service request was resolved over the phone or with the aid of an onsite technician and the resolution time of the service request for the previously performed service requests. The historical solution data may also include identification information such as machine identifiers, model numbers and years of manufacture. The retrieved historical data forms a subset of solution data related to the service request for the machine identified in the service request. This retrieved historical solution data is communicated to the service plan generator 140 through link 75.

The service plan generator 140 receives the retrieved machine status data from the machine status database controller 120 and the retrieved historical solution data from the historical solution database controller 130. The service plan generator 140 performs a diagnostic analysis of the retrieved machine status data and retrieved historical solution data. The diagnostic analysis can be based on a variety of analysis techniques including, but not limited to, threshold analysis, statistical analysis, signature analysis, trend analysis, timing analysis, event sequence analysis, pattern analysis, image processing techniques, quantitative and qualitative state estimation techniques, model based diagnostic technologies, look-up tables, neural network based analysis, fuzzy logic based analysis, a Bayesian network, a causal network, a rule based system, expert systems and other reasoning mechanisms.

For example, the data may be analyzed by building a histogram that is comprised of successful past solutions for the same problem identified in the service request. These solutions may be categorized as being remote solutions or on-site solutions. From these data, the service plan generator 140 may generate a probability for the likely success rate that the problem may be solved during the telephone session with the user. The remote solutions may then be classified and ranked with the most frequent solution being ranked first. Additionally, the service plan generator may determine an estimated time for attempting each class of remote solution and sum the times to provide an estimated phone session time to try each possible remote solution. Alternatively, a subset of the remote solutions may be selected to identify only the most likely solutions to the service representative.

When analyzing the retrieved machine status data using a signature analysis, the data acquisition system 200 comprises at least one analog sensor (not shown) that detects a signature waveform of a part of at least one electronic system 300 and an analog-to-digital converter (not shown) that digitizes the signature waveform. Alternatively, the digital signature waveform may be directly available from the system 300. The historical solution database controller then queries the historical solution database for previously processed service requests involving the same or similar signature waveforms. The retrieved data may then be categorized as being remote solutions or on-site solutions, and classified and ranked as described above. This historical analysis and signature analysis are examples only and other methods for analyzing the data may be used to formulate a service plan and estimated times for attempting the solutions.

Once the analysis of the retrieved data is performed, the service plan generator 140 determines an appropriate repair code for the service request. The repair code indicates whether the service request can be resolved over the phone, i.e. a remote solve, or whether an on-site technician must be dispatched to repair the machine. Moreover, the repair code may indicate, among other things, a fault code indicating at least one fault with the machine or a repair action to be carried out on the machine. Once the repair code is generated, the service plan generator 140 communicates it to the call center access device 60 via the call center interface 64. The call center access device 60 may display the repair code on the display 61. The retrieved machine status data, retrieved historical solution data, fault codes and/or repair instructions may be communicated by the service plan generator to the call center access device 60 as well.

In an alternative embodiment, the service plan generator 140 generates an estimated resolution time for a repair code. The estimated resolution time is an approximation of the time it would take to resolve the particular service request over the phone. In situations where the generated repair code is a remote solve repair code, indicating that the service request can be resolved over the phone, the service plan generator 140 analyzes the retrieved historical solution data, in particular, the resolution time data of the previously performed similar service requests. Once the analysis is completed, the service plan generator 140 generates an estimated resolution time for the remote solve repair code. In situations where the repair code indicates that a remote solve is not possible, the customer service representative has the option to immediately inform the user that an onsite technician will be dispatched. The estimated resolution time is communicated by the service plan generator to the call center access device 60 via the call center interface 64. The call center access device 60 can then display the estimated resolution time on the display 61 on the call center access device.

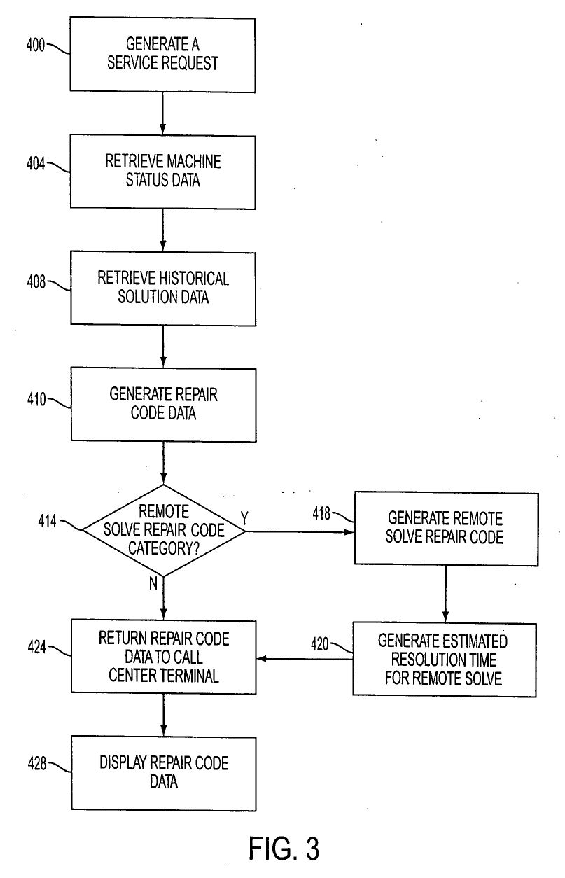

FIG. 3 is a flowchart outlining an exemplary embodiment of a method for a call center system. In response to a service request from a customer concerning a machine, a service request for the machine is generated (block 400). The generated service request includes a machine identifier for the machine. The service request including machine identifier is communicated to a machine status database controller. Machine status data corresponding to the machine identifier of the service request is then retrieved from a machine status database by the machine status database controller (block 404). The retrieved machine status data is communicated to a historical solution database controller. The historical solution database controller retrieves historical solution data from a historical solution database that corresponds to the retrieved machine status data (block 408). The retrieved machine status data and the retrieved historical solution data is communicated to a service plan generator. The service plan generator generates a repair code for the service request that corresponds to the retrieved machine status data and the retrieved historical solution data (block 410).

The exemplary method may also include analyzing the machine status data to determine if the repair code can be categorized as a remote solve (block 414). When the analysis indicates that a remote solve can be performed, a remote solve repair code is generated (block 418). An estimated resolution time for the remote solve may also be generated for the repair code (block 420). The estimated resolution time is an approximation of the time it would take to resolve the particular service request over the phone. Whether the repair code is a remote solve repair code or an on-site solve repair code, the repair code data, including the estimated resolution time for remote solves, is returned to the call center terminal (block 424). The terminal may then display the repair code data for viewing by the customer service representative (block 428).

It should be appreciated that while the systems and methods have been described in relation to an embodiment in which the monitored electronic machines, the data acquisition system, and the call center system are each remotely located on a distributed network, these systems could work equally well if all or portions thereof are incorporated into one or more of the other systems disclosed herein. For example, the service request generator 110 can be implemented in the terminal 60 in accordance with software program instructions stored in memory 63.

As shown in FIGS. 1 and 2, the data acquisition system 200 and call center system 100 can be implemented on special purpose computers, programmed microprocessors or microcontrollers and peripheral integrated circuit elements, ASICs, or other integrated circuits, digital signal processors, hard-wired electronic or logic circuits such as a discreet element circuits, programmable logic devices such as a PLD, PLA, FPGA, PAL, or the like. In general, any device capable of implementing a finite state machine that is in turn capable of implementing the systems of FIGS. 1-2 can be used to implement the data acquisition system 200 and call center system 100.

Furthermore, the methods shown in FIG. 3 may be readily implemented in software using object or object-oriented software development environments that provide portable source code that can be used on a variety of computer, workstation and/or personal digital assistant hardware platforms. Alternatively, the data acquisition system 200 and call center system 100 may be implemented partially or fully in a hardware using standard logic circuits or a VLSI design. Whether software or hardware is used to implement the disclosed systems and methods is dependent on the speed and/or efficiency requirements of the system, the particular function, and the particular software or hardware systems or microprocessor or microcomputer systems being utilized. The systems and methods described above, however, can also be readily implemented in hardware or software using any known or later-developed systems or structures, devices and/or software by those skilled in the applicable art without undue experimentation from the functional description provided above together with a general knowledge of the computer arts.

While various exemplary embodiments have been described and illustrated, it is to be understood that many alternatives, modifications and variations would be apparent to those skilled in the art. Accordingly, Applicants intend to embrace all such alternatives, modifications and variations that follow in the spirit and scope of this disclosure.

What is claimed is:

1. A system for a call center, the system comprising:
a service request generator for generating a service request that includes a machine identifier;
a machine status database controller coupled to the service request generator, the machine status database controller for retrieving machine status data corresponding to the machine identifier of the service request;
a historical solution database controller coupled to the machine status database controller, the historical solution database controller for retrieving historical solution data corresponding to the retrieved machine status data; and
a service plan generator coupled to the service request generator, the service plan generator for generating a repair code for the service request that corresponds to the retrieved machine status data and the retrieved historical solution data.

2. The system of claim 1, wherein the service plan generator generates a remote solve repair code in response to the retrieved historical solution data indicating a remote solution for the service request.

3. The system of claim 2, wherein the service plan generator generates an estimated resolution time for the remote solve repair code.

4. The system of claim 1, wherein the historical solution data includes repair information for previously performed remote solves.

5. The system of claim 4, wherein the historical solution data includes resolution times of the previously performed remote solves.

6. The system of claim 1, wherein the machine status data includes a fault code indicating at least one fault with a machine; and
further wherein the retrieved historical solution data comprises repair information pertaining to the fault code.

7. The system of claim 4, wherein the machine status data includes a model number; and
further wherein the retrieved historical solution data comprises repair information for at least one machine with the same model number.

8. The system of claim 1, wherein the service request further includes customer observation data; and
further wherein the retrieved historical solution data comprises repair information related to the customer observation data.

9. A method for a call center, the method comprising:
generating a service request that includes a machine identifier;
retrieving machine status data corresponding to the machine identifier of the service request;
retrieving historical solution data corresponding to the retrieved machine status data; and
generating a repair code for the service request that corresponds to the retrieved historical solution data.

10. The method of claim 9, wherein the step of generating a repair code for the service request further comprises:
generating a remote solve repair code in response to the retrieved historical solution data indicating a remote solution for the service request.

11. The method of claim 10, further comprising:
generating an estimated remote resolution time corresponding to the retrieved historical solution data.

12. The method of claim 9, wherein the historical solution data includes repair information for previously performed remote solves.

13. The method of claim 12, wherein the historical solution data includes resolution times of the previously performed remote solves.

14. The method of claim 9, wherein the machine status data includes a fault code indicating at least one fault with the machine; and
further wherein the retrieved historical solution data comprises repair information corresponding to the fault code.

15. The method of claim 12, wherein the machine status data includes a model number; and
further wherein the retrieved historical solution data comprises repair information for at least one machine with the same model number.

16. The method of claim 9, wherein the service request further includes customer observation data; and
further wherein the retrieved historical solution data comprises repair information related to the customer observation data.

17. A system for a call center comprising:
a service terminal for receiving a service request for a machine, the service request including a machine identifier;
a machine database querying device coupled to the service terminal, the machine database querying device for querying a machine database using the machine identifier and for retrieving the machine status data corresponding to the machine identifier;
a historical solution database comprising historical solution data from at least one previously performed service request;
a historical solution database controller coupled to the historical solution database, the historical solution database controller for querying the historical solution database with the retrieved machine status data and for retrieving the historical solution data corresponding to the retrieved machine status data; and
a service plan generator coupled to the historical solution database controller, the service plan generator for generating a repair code for the service request that corresponds to the retrieved historical solution data.

18. The system of claim 17, wherein the service plan generator generates a remote solve repair code in response to the retrieved historical solution data indicating a remote solution for the service request.

19. The system of claim 18, further comprising a resolution time generator coupled to the service plan generator and the historical solution database controller, the resolution time generator for generating an estimated resolution time for the remote solve based on the retrieved historical solution data.

20. The system of claim 18, wherein the machine status data includes a fault code indicating at least one fault with the machine.
